(19) United States
(12) Patent Application Publication
(10) Pub. No.: US 2018/0149911 A1
(43) Pub. Date: May 31, 2018

(54) DRIVE CIRCUIT OF DISPLAY DEVICE

(71) Applicant: SHARP KABUSHIKI KAISHA, Sakai City, Osaka (JP)

(72) Inventors: TAKAHIRO YAMAGUCHI, Sakai City (JP); SHIGE FURUTA, Sakai City (JP); JUNICHI YAMADA, Sakai City (JP); HIDEKAZU YAMANAKA, Sakai City (JP); YUHICHIROH MURAKAMI, Sakai City (JP); YASUSHI SASAKI, Sakai City (JP)

(73) Assignee: SHARP KABUSHIKI KAISHA, Sakai City, Osaka (JP)

(21) Appl. No.: 15/574,799

(22) PCT Filed: May 18, 2016
(86) PCT No.: PCT/JP2016/064718

§ 371 Date: Nov. 16, 2017

(30) Foreign Application Priority Data
May 25, 2015 (JP) 2015-105313

(51) Int. Cl. G02F 1/1335; G02F 1/1368; G02F 1/1343; G09G 3/36

(52) U.S. Cl. CPC G02F 1/133512; G02F 1/1368; G02F 1/134336; G09G 2310/08; G09G 3/3688; G09G 2300/0426; G09G 2310/0286; G09G 3/3677

(57) ABSTRACT

A drive circuit of a display device includes a TFT having a source electrode 15, a drain electrode 14, and a gate electrode 13. Provided is an electrically isolated light-shielding film 12 which has a main body portion for shielding a channel portion of the TFT, and an extension portion 20 formed integrally with the main body portion. An auxiliary capacitor C2 is formed by overlapping, in a planar view, the extension portion 20 with an electrode member 21 formed integrally with the source electrode 15. In place of the electrode member 21, an electrode member formed in a same layer as the channel portion and connected to the source electrode 15, an electrode member connected to one conduction electrode of another TFT, or an electrode member formed integrally with the gate electrode 13 may be used. With this, a small-area and low-cost drive circuit including a light-shielded thin film transistor is provided.

### TECHNICAL FIELD

The present invention relates to a drive circuit of a display device, especially to a drive circuit of a display device, the drive circuit including a light-shielded thin film transistor.

### BACKGROUND ART

An active-matrix type display device displays an image by selecting pixel circuits arranged two-dimensionally in units of row and writing voltages in accordance with image data to the selected pixel circuits. Thus, the display device is provided with a scanning line drive circuit for driving scanning lines and a data line drive circuit for driving data lines. Furthermore, a technology (driver monolithic technology) for integrally forming all or a part of the drive circuits on a display panel with the pixel circuits using a manufacturing process for forming a thin film transistor (hereinafter abbreviated as TFT) in the pixel circuit has been put into practical use.

Unlike a transistor in a circuit included in an IC chip, the TFT formed on the display panel is irradiated with light. When the TFT is irradiated with light, characteristics of the TFT is changed gradually with a passage of time (this phenomenon is called characteristic shift). For example, when the TFT is irradiated with light, a threshold voltage of the TFT is increased gradually or is decreased gradually. When the characteristic shift of the TFT occurs in the display device, brightness of a pixel is changed and display quality is degraded. Thus, as a method for preventing the characteristic shift of the TFT due to light, there is known a method of providing a light-shielding film covering a channel portion of the TFT and blocking light incident to the TFT.

When the light-shielding film is provided to the TFT, the channel portion of the TFT may be influenced by a potential of the light-shielding film and the TFT may malfunction. In order to solve this problem, Patent Document 1 describes a method of fixing the potential of the light-shielding film by constantly applying an off potential of the TFT to the light-shielding film provided to the TFT. With this method, it is possible to prevent photo carriers from being generated in the TFT and reduce an off-leakage current flowing through the TFT.

### PRIOR ART DOCUMENT

### Patent Document

[Patent Document 1] Japanese Laid-Open Patent Publication No. Hei 10-111520

### SUMMARY OF THE INVENTION

### Problems to be Solved by the Invention

However, in the method described in Patent Document 1, in order to fix the potential of the light-shielding film, a wiring for supplying a potential to the light-shielding film and a contact hole for connecting the wiring and the light-shielding film are necessary. Therefore, a circuit area is increased. Furthermore, since a process for forming the contact hole for connecting the wiring and the light-shielding film is necessary, a manufacturing process becomes complicated and a manufacturing cost is increased.

Accordingly, an object of the present invention is to provide a small-area and low-cost drive circuit of a display device, the drive circuit including a light-shielded thin film transistor.

### Means for Solving the Problems

According to a first aspect of the present invention, there is provided a drive circuit of a display device, formed on a display panel, the drive circuit including: a thin film transistor having a first conduction electrode, a second conduction electrode, and a control electrode; an electrically isolated light-shielding film having a main body portion configured to shield a channel portion of the thin film transistor, and an extension portion formed integrally with the main body portion; and an auxiliary capacitor formed by overlapping the extension portion of the light-shielding film with an electrode member in a planar view.

According to a second aspect of the present invention, in the first aspect of the present invention, an off potential of the thin film transistor is fixedly applied to the electrode member.

According to a third aspect of the present invention, in the second aspect of the present invention, the electrode member is formed integrally with the first conduction electrode.

According to a fourth aspect of the present invention, in the second aspect of the present invention, the electrode member is formed in a same layer as the channel portion and is electrically connected to the first conduction electrode.

According to a fifth aspect of the present invention, in the fourth aspect of the present invention, the electrode member is formed between the first and second conduction electrodes.

According to a sixth aspect of the present invention, in the second aspect of the present invention, the electrode member is electrically connected to one conduction electrode of another thin film transistor other than the thin film transistor.

According to a seventh aspect of the present invention, in the sixth aspect of the present invention, the electrode member is formed integrally with the one conduction electrode of the other thin film transistor.

According to an eighth aspect of the present invention, in the sixth aspect of the present invention, the electrode member is formed in a same layer as the channel portion.

According to a ninth aspect of the present invention, in the sixth aspect of the present invention, the electrode member is formed in a same layer as the control electrode.

According to a tenth aspect of the present invention, in the first aspect of the present invention, the electrode member is formed integrally with the control electrode.

According to an eleventh aspect of the present invention, there is provided a display device including: a display panel including a plurality of scanning lines, a plurality of data lines, and a plurality of pixel circuits; a scanning line drive circuit configured to drive the scanning lines; and a data line drive circuit configured to drive the data lines, wherein at least a part of at least one of the scanning line drive circuit and the data line drive circuit is formed on the display panel and includes: a thin film transistor having a first conduction electrode, a second conduction electrode, and a control electrode; an electrically isolated light-shielding film having a main body portion configured to shield a channel portion of the thin film transistor, and an extension portion formed integrally with the main body portion; and an auxiliary capacitor formed by overlapping the extension portion of the light-shielding film with an electrode member in a planar view.

### Effects of the Invention

According to the first aspect of the present invention, it as possible to stabilize a potential of the light-shielding film using the auxiliary capacitor formed between the light-shielding film, and the electrode member, and reduce an influence which the light-shielding film exerts on the thin film transistor. Therefore, it is possible to prevent malfunction of the drive circuit due to a provision of the light-shielding film. Furthermore, since the light-shielding film is electrically isolated, it is not necessary to provide a wiring for supplying a potential to the light-shielding film and a contact hole for connecting the wiring and the light-shielding film. Therefore, it is possible to prevent an increase in a circuit area and a complication of a manufacturing process. Consequently, it is possible to provide a small-area and low-cost drive circuit of a display device, the drive circuit including a light-shielded thin film transistor.

According to the second aspect of the present invention, it is possible to stabilize the potential of the light-shielding film and reduce an off-leakage current due to the provision of the light-shielding film, by fixedly applying; the off potential of the thin film transistor to the electrode member which is one electrode of the auxiliary capacitor. Furthermore, by reducing the off-leakage current, it is possible to prevent the malfunction of the drive circuit due to the provision of the light-shielding film when the thin film transistor is in an off state and the second conduction electrode is in a floating state.

According to the third aspect of the present invention, the auxiliary capacitor for stabilizing the potential of the light-shielding film can be formed, using the electrode member formed integrally with the first conduction electrode of the thin film transistor.

According to the fourth aspect of the present invention, the auxiliary capacitor for stabilizing the potential of the light-shielding film can be formed, using the electrode member formed in the same layer as the channel portion of the thin film transistor and electrically connected to the first conduction electrode of the thin film transistor.

According to the fifth aspect of the present invention, the auxiliary capacitor can be formed without exerting a large influence on a layout of other parts, by forming the electrode member between the first and second conduction electrodes.

According to the sixth aspect of the present invention, it is possible to apply, to the electrode member, an off potential fixedly applied to the one conduction electrode of the other thin film transistor, stabilize the potential of the light-shielding film, and reduce the off-leakage current due to the provision of the light-shielding film, by electrically connecting the electrode member to the one conduction electrode of the other thin film transistor. Furthermore, by reducing the off-leakage current, it is possible to prevent the malfunction of the drive circuit due to the provision of the light-shielding film when the thin film transistor is in the off state and the second conduction electrode is in the floating state.

According to the seventh aspect of the present invention, the auxiliary capacitor for stabilizing the potential of the light-shielding film can be formed, using the electrode member formed integrally with the one conduction electrode of the other thin film transistor.

According to the eighth aspect of the present invention, the auxiliary capacitor for stabilizing the potential of the light-shielding film can be formed, using the electrode member formed in the same layer as the channel portion of the thin film transistor and electrically connected to the one conduction electrode of the other thin film transistor.

According to the ninth aspect of the present invention, the auxiliary capacitor for stabilizing the potential of the light-shielding film can be formed, using the electrode member formed in the same layer as the control electrode of the thin film transistor and electrically connected to the one conduction electrode of the other thin film transistor.

According to the tenth aspect of the present invention, the auxiliary capacitor for stabilizing the potential of the light-shielding film can be formed, using the electrode member formed integrally with the control electrode of the thin film transistor.

According to the eleventh aspect of the present invention, a reliable and low-cost display device can be provided using a small-area and low-cost drive circuit of a display device, the drive circuit including a light-shielded thin film transistor.

### BRIEF DESCRIPTION OF THE DRAWINGS

FIG. 1 is a block diagram showing a configuration of a liquid crystal display device including a scanning line drive circuit according to a first embodiment of the present invention.

FIG. 2 is a block diagram showing a configuration of a shift register functioning as the scanning line drive circuit shown in FIG. 1.

FIG. 3 is a circuit diagram of a unit circuit of the shift register shown in FIG. 2.

FIG. 4 is a timing chart of the shift register shown in FIG. 2.

FIG. 5 is a layout diagram of a protection target transistor and its neighborhood included in the shift register shown in FIG. 2.

FIG. 6 is a diagram showing shapes of a light-shielding film and a semiconductor layer pattern shown in FIG. 5.

FIG. 7 is a schematic diagram showing capacitors associated with the light-shielding film shown in FIG. 5.

FIG. 8 is a timing chart of a shift register according to a comparative example when malfunctioning.

FIG. 9 is a layout diagram of a protection target transistor and its neighborhood included in a scanning line drive circuit according to a first example of a second embodiment of the present invention.

FIG. 10 is a diagram showing a shape of a semiconductor layer pattern shown in FIG. 9

FIG. 11 is a layout diagram of a protection target transistor and its neighborhood included in a scanning line drive circuit according to a second example of the second embodiment of the present invention.

FIG. 12 is a diagram showing shapes of a light-shielding film and a semiconductor layer pattern shown in FIG. 11.

FIG. 13 is a layout diagram of a protection target transistor and its neighborhood included in a scanning line drive circuit according to a first example of a third embodiment of the present invention.

FIG. 14 is a layout diagram of a protection target transistor and its neighborhood included in a scanning line drive circuit according to a second example of the third embodiment of the present invention.

FIG. 15 is a layout diagram of a protection target transistor and its neighborhood included in a scanning line drive circuit according to a third example of the third embodiment of the present invention.

FIG. 16 is a layout diagram of a protection target transistor and its neighborhood included in a scanning line drive circuit according to a fourth embodiment of the present invention.

FIG. 17 is a block diagram showing a configuration of a liquid crystal display device including a data line drive circuit according to a fifth embodiment of the present invention.

FIG. 18 is a circuit diagram of a data line selection circuit shown in FIG. 17.

### MODES FOR CARRYING OUT THE INVENTION

In the following, drive circuits of display devices according to embodiments of the present invention will be described referring to the drawings. The below-described drive circuit according to each embodiment includes a plurality of TFTs (Thin Film Transistors). From among the plurality of the TFTs included in the drive circuit, one or more TFTs are selected as a protection target transistor, and a light-shielding film and an auxiliary capacitor are provided corresponding to each protection target transistor. In first to fourth embodiments, scanning line drive circuits including the TFT provided with the light-shielding film and the auxiliary capacitor will be described. In a fifth embodiment, a data line drive circuit including the TFT provided with the light-shielding film and the auxiliary capacitor will be described. It is pointed out in advance that the drive circuits according to the first to fifth embodiments are merely examples of drive circuits to which the present invention is applied, and that the present invention can be applied to arbitrary drive circuits formed on a display panel.

In the following description, a signal input or output through a terminal is called by a same name as the terminal (for example, a signal input through a clock terminal CKA is referred to as a clock signal CKA). Furthermore, a potential which turns on a transistor when supplied to a gate electrode is referred to as an on potential, and a potential which turns off the transistor when supplied to the gate electrode is referred to as an off potential. For example, for an N-channel type transistor, a high-level potential is the on potential, and a low-level potential is the off potential. Furthermore, it is assumed that a threshold voltage of the transistor is Vth, the high-level potential is VDD, and the low-level potential is VSS. Furthermore, it is assumed that m and n are integers not less than 2.

### First Embodiment

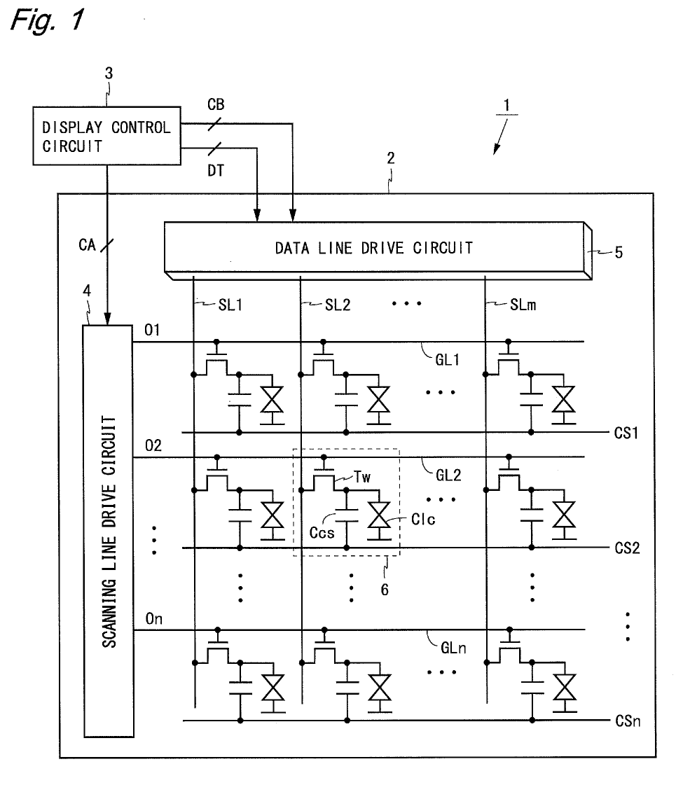

FIG. 1 is a block diagram showing a configuration of a liquid crystal display device including a scanning line drive circuit according to a first embodiment of the present invention. A liquid crystal display device 1 shown in FIG. 1 includes a liquid crystal panel 2, a display control circuit 3, a scanning line drive circuit 4, and a data line drive circuit 5.

The liquid crystal panel 2 includes n scanning lines GL1 to GLn, m data lines SL1 to SLm, n storage capacitance lines CS1 to CSn, and (m×n) pixel circuits 6. The scanning lines GL1 to GLn are arranged in parallel to each other. The data lines SL1 to SLm are arranged in parallel to each other so as to intersect with the scanning lines GL1 to GLn perpendicularly. The scanning lines GL1 to GLn and the data lines SL1 to SLm intersect at (m×n) points. The (m×n) pixel circuits 6 are arranged near intersections of the scanning lines GL1 to GLn and the data lines SL1 to SLm. The storage capacitance lines CS1 to CSn are arranged in parallel to the scanning lines GL1 to GLn.

The pixel circuit 6 includes a transistor Tw (write control transistor), a liquid crystal capacitance Clc, and a storage capacitance Ccs. A gate electrode of the transistor Tw is connected to a corresponding scanning line. A source electrode of the transistor Tw is connected to a corresponding data line. A drain electrode of the transistor Tw is connected to one electrodes of the liquid crystal capacitance Clc and the storage capacitance Ccs. The other electrode of the liquid crystal capacitance Clc is connected to a common electrode (not shown). The other electrode of the storage capacitance Ccs is connected to a corresponding storage capacitance line. The storage capacitance lines CS1 to CSn are driven by a storage capacitance line drive circuit (not shown) provided at the outside of the liquid crystal panel 2.

The scanning line drive circuit 4 and the data line drive circuit 5 are drive circuits of the liquid crystal display device 1. The scanning line drive circuit 4 drives the scanning lines GL1 to GLn, and the data line drive circuit 5 drives the data lines SL1 to SLm. The display control circuit 3 outputs a control signal CA to the scanning line drive circuit 4 and outputs a control signal CB and a data signal DT to the data line drive circuit 5. The scanning line drive circuit 4 sequentially selects one scanning line from among the scanning lines GL1 to GLn based on the control signal CA, and applies the high-level potential to the selected scanning line. With this, m pixel circuits 6 corresponding to the selected scanning line are selected collectively. The data line drive circuit 5 respectively applies m voltages in accordance with the data signal DT to the data lines SL1 to SLm based on the control signal CB. With this, the m voltages are written to the selected m pixel circuits 6, respectively.

The scanning line drive circuit 4 is formed on the liquid crystal panel 2 together with the pixel circuit 6 using a same manufacturing process for the pixel circuits 6. The data line drive circuit 5 is included in one or more IC chips. The IC chip including the data line drive circuit 5 is mounted on a surface of the liquid crystal panel 2. Note that all or a part of the data line drive circuit 5 may be formed on the liquid crystal panel 2 together with the pixel circuits 6 using the same manufacturing process for the pixel circuits 6.

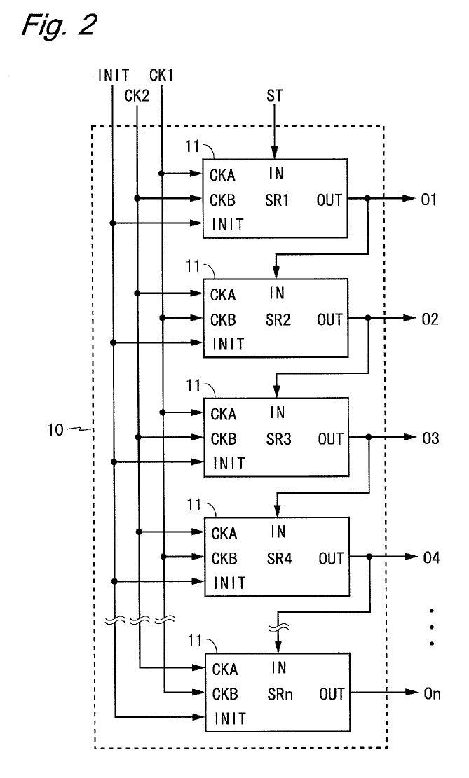

A case in which a shift register is used as the scanning line drive circuit 4 will be described below. FIG. 2 is a block diagram showing; a configuration of a shift register functioning as the scanning line drive circuit 4. A shift register 10 shown in FIG. 2 has a configuration in which n unit circuits 11 are connected in multi-stage. The unit circuit 11 has an input terminal IN, clock terminals CKA, CKB, an initialization terminal INIT, and an output terminal OUT. A start signal ST, two-phase clock signals CK1, CK2, and an initialization signal INIT are supplied from the display control circuit 3 to the shift register 10 as the control signal CA.

As shown in FIG. 2, the start signal ST is supplied to the input terminal IN of the unit circuit 11 in a first stage. The clock signal CK1 is supplied to the clock terminal CKA of the unit circuit 11 in an odd-numbered stage and the clock terminal CKB of the unit circuit 11 in an even-numbered stage. The clock signal CK2 is supplied to the clock terminal CKB of the unit circuit 11 in the odd-numbered stage and the clock terminal CKA of the unit circuit 11 in the even-numbered stage. The initialization signal INIT is supplied to the initialization terminals INIT of the n unit circuits 11. The output signal OUT of the unit circuit 11 is output to the outside as output signals O1 to On, and is supplied to the input terminal IN of the unit circuit 11 in a next stage. The high-level potential VDD and the low-level potential VSS are supplied from a power supply circuit (not shown) to each unit circuit 11.

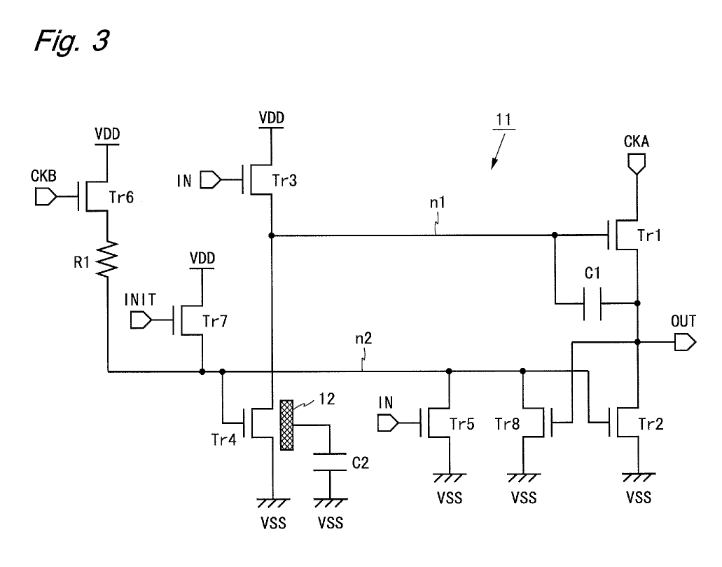

FIG. 3 is a circuit diagram of the unit circuit 11. The unit circuit 11 shown in FIG. 3 includes eight transistors Tr1 to Tr8, a capacitor C1, and a resistor R1. All the transistors Tr1 to Tr8 are N-channel type TFTs. In the unit circuit 11, the transistor Tr4 is selected as a protection target transistor, and a light-shielding film 12 and an auxiliary capacitor C2 are provided corresponding to the transistor Tr4.

A drain electrode of the transistor Tr1 is connected to the clock terminal CKA. A source electrode of the transistor Tr1 is connected to a drain electrode of the transistor Tr2, a gate electrode of the transistor Tr8, and the output terminal OUT. A gate electrode of the transistor Tr1 is connected to a source electrode of the transistor Tr1 and a drain electrode of the transistor Tr4. A gate electrode of the transistor Tr2 is connected to a gate electrode of the transistor Tr4, drain electrodes of the transistors Tr5, Tr8, a source electrode of the transistor Tr7, and one end (lower end in FIG. 3) of the resistor R1. Gate electrodes of the transistors Tr3, Tr5 are connected to the input terminal IN, and a gate electrode of the transistor Tr7 is connected to the initialization terminal INIT. A gate electrode of the transistor Tr6 is connected to the clock terminal CKB, and a source electrode of the transistor Tr6 is connected to the other end of the resistor R1. The high-level potential VDD is fixedly applied to drain electrodes of the transistors Tr3, Tr6, Tr7. The low-level potential VSS is fixedly applied to source electrodes of the transistors Tr2, Tr4, Tr5, Tr8. The capacitor C1 is provided between the gate electrode and the source electrode of the transistor Tr1. Hereinafter, a node to which the gate electrode of the transistor Tr1 is connected is referred to as n1, and a node to which the gate electrode of the transistor Tr2 is connected is referred to as n2.

The light-shielding film 12 and the auxiliary capacitor C2 are provided corresponding to the transistor Tr4. The light-shielding film 12 has a main body portion for covering a channel portion of the transistor Tr4, and an extension portion formed integrally with the main body portion (details will be described later). By forming the extension portion of the light-shielding film 12 and an electrode member so as to overlap in a planar view, the auxiliary capacitor C2 is formed between the light-shielding film 12 and the electrode member. The light-shielding film 12 is not connected to other conductive members (wiring, electrode, and the like), and is formed so as to be electrically isolated. The light-shielding film 12 is always in a floating state. A potential of the light-shielding film 12 can not be controlled directly and can not be fixed. Note that the unit circuit 11 does not have a light-shielding film and an auxiliary capacitor corresponding to the transistors Tr1 to Tr3, Tr5 to Tr8.

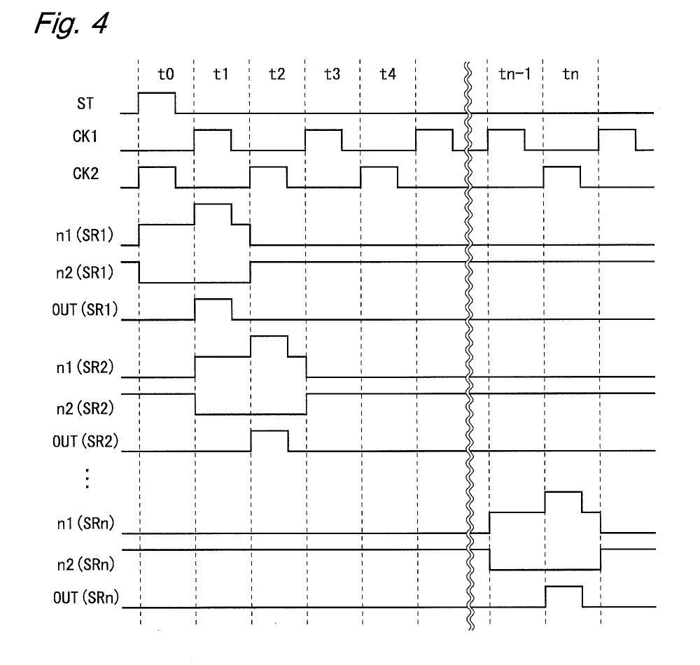

The shift register 10 performs an initialization when the initialization signal INIT is at a high level, and performs a normal operation when the initialization signal INIT is at a low level. FIG. 4 is a timing chart of the shift register 10 when performing the normal operation. When performing the normal operation, since the initialization signal INIT is at the low level, the transistor Tr7 turns off. Thus, the transistor Tr7 does not exert any influence on the normal operation of the shift register 10.

When performing the normal operation, the clock signal CK1 becomes the high level and the low level in a predetermined cycle. A high level period of the clock signal CK1 is shorter than a half cycle. The clock signal CK2 is a signal obtained by delaying the clock signal CK1 by the half cycle. The start signal ST becomes the high level in a high level period of the clock signal CK2 in a period t0.

The normal operation of the unit circuit 11 in the first stage will be described below. In the unit circuit 11 in the first stage, the start signal ST is the input signal IN, the clock signal CK1 is the clock signal CKA, and the clock signal CK2 is the clock signal CKB.

In the period t0 the input signal IN changes to the high level. Thus, the transistor Tr1 turns on, and a potential of the node n1 becomes (VDD−Vth). When the potential of the node n1 exceeds an on level of the transistor on the way, the transistor Tr1 turns on. Since the clock signal CKA is at the low level at this time, the output signal OUT remains at the low level.

Furthermore, when the input signal IN changes to the high level, the transistor Tr5 turns on. Since the clock signal CKB is at the high level at this time, the transistor Tr6 also turns on. Since the resistor R1 is provided between the source electrode of the transistor Tr6 and the node n2, when both of the transistors Tr5, Tr6 turn on, a potential of the node n2 becomes a potential close to the low-level potential VSS (off potential of the transistor). Thus, the transistors Tr2, Tr4 turn off. In a second half part of the period t0, the input signal IN changes to the low level. Thus, the transistors Tr3, Tr5 turn off. After that, the node n1 holds the high-level potential in the floating state.

In a period t1, the clock signal CKA changes to the high level. Since the transistor Tr1 is in an on state at this time, a potential of the output terminal OUT is increased and the output signal OUT becomes the high level. Accordingly, the potential of the node n1 in the floating state is pushed up) via the capacitor C1 and a parasitic capacitance of the transistor Tr1, and the potential of the node n1 is increased close to (2×VDD−Vth) (bootstrap operation). Since the potential of the node n1 becomes higher than (VDD+Vth), the potential of the output terminal OUT becomes equal to the high-level potential VDD potential without threshold drop) of the clock signal CKA. At this time, the transistor Tr8 turns on and fixes the potential of the node n2 to the low-level potential VSS. In a second half part of the period t1, the clock signal CKA changes to the low level. Thus, the output signal OUT becomes the low level, the potential of the node n1 returns to a same potential (VDD−Vth) as in the period t0, and the transistor Tr8 turns off.

In a period t2, the clock signal CKB changes to the high level. Thus, the transistor Tr6 turns on, and the high-level potential is applied to the node n2. Since the transistor Tr5 is in an off state at this time, the potential of the node n2 becomes (VDD−Vth). Thus, the transistor Tr4 turns on, the potential of the node n1 becomes the low level, and the transistor Tr1 turns off. When the potential of the node n2 exceeds the on level of the transistor on the way, the transistor Tr2 turns on and the output signal OUT is fixed to the low level again.

In a second half part of the period t2, the clock signal CKB changes to the low level. Thus, the transistor Tr6 turns off. After that, in the high level period of the clock signal CKB, the transistor Tr1; turns on and the high-level potential is applied to the node n2. In a low level period of the clock signal CKB, the node n2 keeps the high-level potential in the floating state. In this manner, an output signal OUT of the unit circuit 11 in the first stage becomes the high level (potential is VDD) in the high level period of the clock signal CK1 in the period t1.

The output signal OUT of the unit circuit 11 in the first stage is supplied to the input terminal IN of the unit circuit 11 in a second stage. In the periods t1 to t3, the unit circuit 11 in the second stage operates in a manner similar to that the unit circuit 11 in the first stage operates in the periods t0 to t2. An output, signal OUT of the unit circuit 11 in the second stage is supplied to the input terminal IN of the unit circuit 11 in a third stage. In the periods t2 to t4, the unit circuit 11 in the third stage operates in a manner similar to that the unit circuit 11 in the first stage operates in the periods t0 to t2. The n unit circuits 11 perform similar operations sequentially, with delaying by the half cycle of the clock signal CK1. Therefore, the output signals alto On of the shift register 10 sequentially become the high level in a same length of time as the high level period of the clock signal CK1, with delaying by the half cycle of the clock signal CK1.

When performing the initialization, the initialization signal INIT changes to the high level. At this time, the transistor Tr7 turns on and the potential of the node n2 becomes (VDD−Vth). Thus, the transistor Tr4 turns on, the potential of the node n1 becomes the low level, and the transistor Tr1 turns off. Furthermore, the transistor Tr2 turns on, and the output signal OUT becomes the low level.

Note that the unit circuit 11 operates in a manner similar to as described above even if the unit circuit 11 does not include the transistor Tr8. However, the unit circuit 11 which does not include the transistor Tr8 is likely to be influenced by noise when the node n2 is in the floating state.

FIG. 5 is a layout diagram of the transistor Tr4 and its neighborhood. The transistors included in the unit circuit 11, including the transistor Tr4, are formed by laminating a semiconductor layer, a gate layer, and a source layer sequentially from a lower layer. The light-shielding film 12 is formed in a layer lower than the semiconductor layer of the transistor. The semiconductor layer is formed using polysilicon, for example. In the following, in layout diagrams such as FIG. 5, a cross-hatched portion represents the light-shielding film, a dot pattern portion represents a semiconductor layer pattern, a right-down oblique line portion represents a gate layer pattern, and a left-down oblique line portion represents a source layer pattern. Furthermore, at a position where two or more layers overlap, a pattern in an uppermost layer is described, and a contact hole connecting the layers is shown by a broken line.

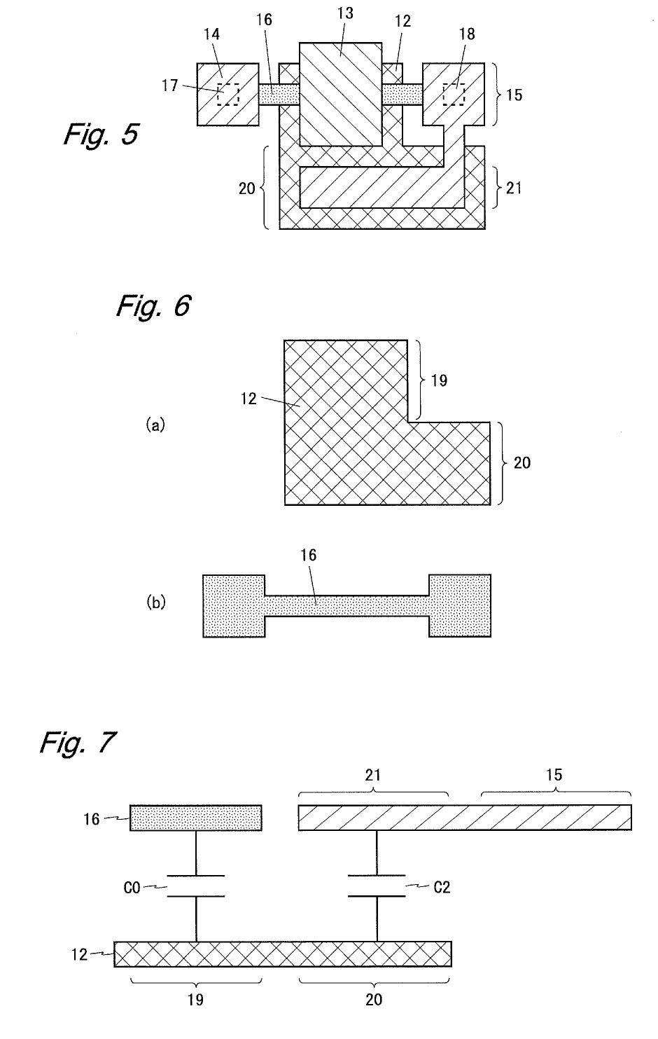

The transistor Tr4 has a gate electrode 13, a drain electrode 14, a source electrode 15, and a semiconductor portion 16. The semiconductor portion 16 is formed in the semiconductor layer, the gate electrode 13 is formed in the gate layer, and the drain electrode 14 and the source electrode 15 are formed in the source layer. The drain electrode 14 and the source electrode 15 are formed with providing a predetermined space therebetween. The semiconductor portion 16 is formed between the drain electrode 14 and the source electrode 15, and has a shape shown in FIG. 6(b). The gate electrode 13 is formed between the drain electrode 14 and the source electrode 15 so as to overlap with the semiconductor portion 16 in a planar view. A part of the semiconductor portion 16 that overlaps with the gate electrode 13 in a planar view is a channel portion (a portion where a channel is formed) of the transistor Tr4. The drain electrode 14 and the semiconductor portion 16 are electrically connected using a contact hole 17. The source electrode 15 and the semiconductor portion 16 are electrically connected using a contact hole 18.

The light-shielding film 12 has a shape shown in FIG. 6(a). The light-shielding film 12 has a main body portion 19 for shielding the channel portion of the transistor Tr4, and an extension portion 20 formed integrally with the main body portion 19. In the source layer, an electrode member 21 is formed integrally with the source electrode 15. The extension portion 20 of the light-shielding film 12 and the electrode member 21 are formed so as to overlap in a planar view (so that the extension portion 20 covers the electrode member 21). With this, the auxiliary capacitor C2 (FIG. 3) is formed between the light-shielding film 12 and the source electrode 15. As described above, the drain electrode 14 becomes the floating state in the low level period of the clock signal CKB, and the low-level potential VSS is fixedly applied to the source electrode 15.

FIG. 7 is a schematic diagram showing capacitors associated with the light-shielding film 12. A capacitor C0 is formed between the light-shielding film 12 and the semiconductor portion 16 by overlapping the main body portion 19 of the light-shielding film 12 with the semiconductor portion 16 in a planar view. In addition, the auxiliary capacitor C2 is formed between the light-shielding film 12 and the source electrode 15 by overlapping the extension portion 20 of the light-shielding film 12 with the electrode member 21 in a planar view. In this manner, the capacitor C0 exists between the light-shielding film 12 and the semiconductor portion 16, and the auxiliary capacitor C2 exists between the light-shielding film 12 and the source electrode 15. The capacitor C0 is inevitably formed when the light-shielding film 12 is provided to the transistor Tr4. The auxiliary capacitor C2 is intentionally formed by extending the light-shielding film, 12 and providing the electrode member 21.

Hereinafter, a shift register in which unit circuits in which the light-shielding film 12 is provided corresponding to the transistor Tr4 but the auxiliary capacitor C2 is not provided (unit circuit obtained by deleting the auxiliary capacitor C2 from the unit circuit 11) are connected in multi-stage is referred to as a shift register according to a comparative example. As described below, the shift register according to the comparative example may malfunction due to a provision of the light-shielding film 12.

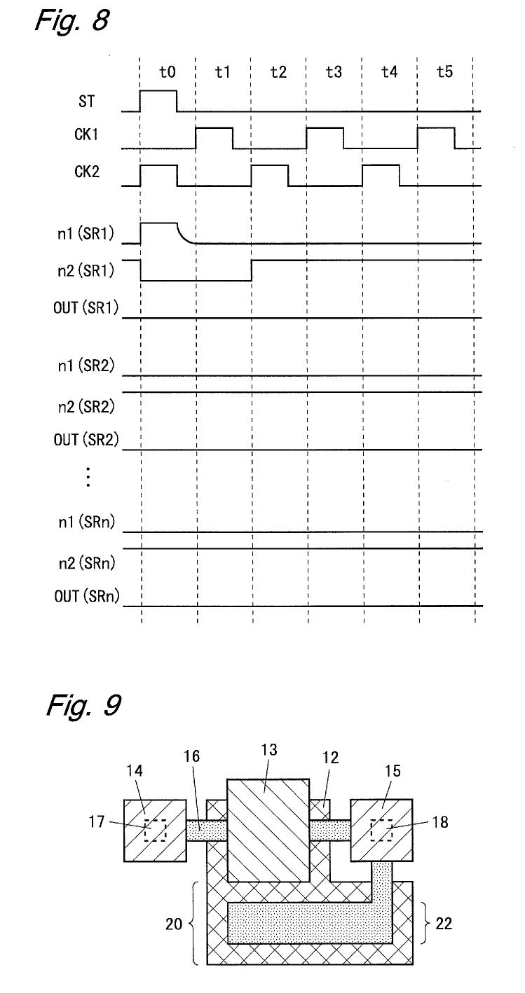

FIG. 8 is a timing chart of the shift register according to the comparative example when malfunctioning. When the light-shielding film 12 is provided to the transistor Tr4, the capacitor C0 shown in FIG. 7 is formed. Since the light-shielding film 12 is in the floating state, charge of the light-shielding film 12 fluctuates under an influence of the semiconductor portion. Conversely, operation of the transistor Tr4 influenced by the charge of the light-shielding film 12. For example, a threshold voltage of the transistor Tr4 may be increased or an off-leakage current of the transistor Tr4 may be increased under the influence of the charge of the light-shielding film 12.

In the unit circuit in the first stage of the shift register according to the comparative example, the transistors Tr3, Tr5 turn on in a high level period of the start signal ST in the period t0. Thus, the potential of the node n1 becomes the high level, the potential of the node n2 becomes the low level, and the transistor Tr4 turns off. When the start signal ST changes to the low level in a second half part of the period t0, the transistors Tr3, Tr5 turn off, and the nodes n2 become the floating state.

At an end of the high level period of the start signal ST in the period t0, the drain potential of the transistor Tr4 (potential of node n1) is at the high level, and the source potential of the transistor Tr4 is at the low level. Since the transistor Tr4 is in the off state at this time, the potential of the node n1 is decreased by the off-leakage current flowing through the transistor Tr4. When the off-leakage current is sufficiently small, the shift register according to the comparative example operates correctly.

However, in shift register according to the comparative example, a large off-leakage current may flow through the transistor Tr4 provided with the light-shielding film 12 and included in the unit circuit in the first stage, and the potential of the node n1 may become the low level in the period t0. In this case, even when the clock signal CK1 (clock signal CKA of the unit circuit in the first stage) changes to the high level in the period t1, the shift register according to the comparative example can not perform the bootstrap operation correctly, and the output signal OUT of the unit circuit in the first stage remains at the low level. In this manner, the shift register according to the comparative example may malfunction due to the provision of the light-shielding film 12 to the transistor Tr4.

On the contrary, in the unit circuit 11 of the shift register 10, the light-shielding film 12 and the auxiliary capacitor C2 are provided corresponding to the transistor Tr4. The auxiliary capacitor C2 is provided between the light-shielding film 12 and the source electrode 15 of the transistor Tr4, and the low-level potential VSS is fixedly applied to the source electrode 15 of the transistor Tr4. Thus, even when the light-shielding film 12 is in the floating state, the charge of the light-shielding film 12 is unlikely to fluctuate, and the potential of the light-shielding film 12 is unlikely to change. Therefore, the operation of the transistor Tr4 is less influenced by the charge of the light-shielding film 12. For example, the threshold voltage of the transistor Tr4 is unlikely to fluctuate and the off-leakage current of the transistor Tr4 is reduced. Therefore, according to the shift register 10, it is possible to prevent malfunction due to the provision of the light-shielding film 12 to the transistor Tr4.

Furthermore, the light-shielding film 12 is formed so as to be electrically isolated. Thus, a wiring for supplying a potential to the light-shielding film 12 and a contact hole for connecting the wiring and the light-shielding film 12 are unnecessary. Furthermore, when forming the shift register 10, a process for forming the contact hole for connecting the wiring and the light-shielding film 12 is unnecessary. Therefore, according to the shift register 10, it is possible to prevent the malfunction due to the provision of the light-shielding film 12 to the transistor Tr4, without increasing a circuit area and without adding a process of forming the contact hole connected to the light-shielding film.

As described above, the scanning line drive circuit 4 according to the present embodiment is formed on a display panel (liquid crystal panel 2) and includes a thin film transistor (transistor Tr4) having a first conduction electrode (source electrode 15), a second conduction electrode (drain electrode 14), and a control electrode (orate electrode 18), the electrically isolated light-shielding film 12 having the main body portion 19 for shielding the channel portion of the thin film transistor, and the extension portion 20 formed integrally with the main body portion 19, and the auxiliary capacitor C2 formed by overlapping the extension portion 20 of the light-shielding film 12 with the electrode member 21 in a planar view.

Thus, it is possible to stabilize the potential of the light-shielding film using the auxiliary capacitor formed between the light-shielding film and the electrode member, and reduce an influence which the light-shielding film exerts on the thin film transistor. Therefore, it is possible to prevent the malfunction of the drive circuit due to the provision of the light-shielding film. Furthermore, since the light-shielding film is electrically isolated, it is not necessary to provide a wiring for supplying a potential to the light-shielding film and a contact hole for connecting the wiring and the light-shielding film. Therefore, it is possible to prevent an increase in the circuit area and a complication of the manufacturing process. Consequently, it is possible to provide a small-area and low-cost drive circuit of a display device, the drive circuit including a light-shielded thin film transistor.

Furthermore, it is possible to stabilize the potential of the light-shielding film and reduce the off-leakage current due to the provision of the light-shielding film, by fixedly applying the off potential of the thin film transistor to the electrode member which is one electrode of the auxiliary capacitor. Furthermore, by reducing the off-leakage current, it is possible to prevent the malfunction of the drive circuit due to the provision of the light-shielding film when the thin film transistor is in the off state and the second conduction electrode is in the floating state. Furthermore, the auxiliary capacitor for stabilizing the potential of the light-shielding film can be formed, using the electrode member formed integrally with the first conduction electrode (source electrode 15) of the protection target thin film transistor.

Furthermore, the liquid crystal display device 1 shown in FIG. 1 includes a display panel (liquid crystal panel including the plurality of the scanning lines GL1 to GLn, the plurality of the data lines SL1 to SLm, and the plurality of the pixel circuits 6, the scanning line drive circuit 4 for driving the scanning lines, and the data line drive circuit 5 for driving the data lines. The scanning line drive circuit 4 (shift register 10) is formed on the display panel and has an above-described configuration. Therefore, a reliable and low-cost display device can be provided using a small-area and low-cost drive circuit of a display device, the drive circuit including a light-shielded thin film transistor.

Note that when the protection target transistor is of a P-channel type, the auxiliary capacitor is formed between the light-shielding film and the source electrode, by overlapping, in a planar view, the extension portion of the light-shielding film with the electrode member formed integrally with the source electrode of the protection target transistor. In this case, the high-level potential is fixedly applied to the source electrode as the off potential of the transistor.

### Second Embodiment

A scanning line drive circuit according to a second embodiment of the present invention is different from that according to the first embodiment in a method of forming the auxiliary capacitor C2. In the present embodiment, the electrode member is formed in a same layer as the channel portion of the protection target transistor, and is electrically connected to the first conduction electrode of the protection target transistor. Differences from the first embodiment will be described below.

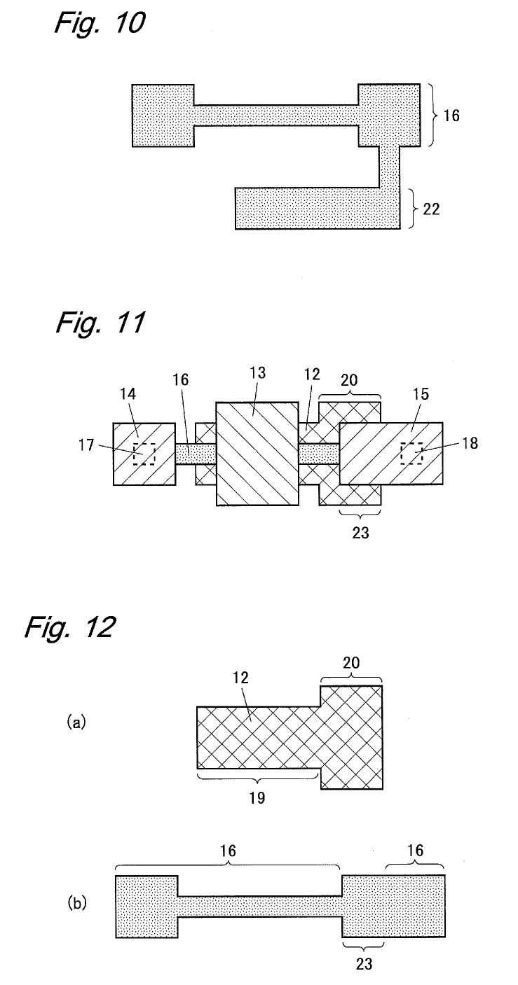

FIG. 9 is a layout diagram of the transistor Tr4 and its neighborhood in a scanning line drive circuit according to a first example of the present embodiment. In the first example, in order to form the auxiliary capacitor C2, an electrode member 22 is formed integrally with the semiconductor portion 16 in the semiconductor layer. A semiconductor layer pattern has a shape shown in FIG. 10. The extension portion 20 of the light-shielding film 12 and the electrode member 22 are formed so as to overlap in a planar view (so that the extension portion 20 covers the electrode member 22). The electrode member 22 is electrically connected to the source electrode 15 using the contact hole 18. With this, as with the first embodiment, the auxiliary capacitor C2 is formed between the light-shielding film 12 and the source electrode 15.

FIG. 11 is a layout diagram of the transistor Tr4 and its neighborhood in a scanning line drive circuit according to a second example of the present embodiment. Also in the second example, in order to form the auxiliary capacitor C2, an electrode member 23 is formed integrally with the semiconductor portion 16 in the semiconductor layer. The electrode member 23 is formed between the drain electrode 14 and the source electrode 15. A semiconductor layer pattern has a shape shown in FIG. 12(b). The light-shielding film 12 has a shape shown in FIG. 12(a). The light-shielding film 12 has the main body portion 19 for shielding the channel portion of the transistor Tr4, and the extension portion 20 formed integrally with the main body portion 19. The extension portion 20 of the light-shielding film 12 and the electrode member 23 are formed so as to overlap in a planar view (so that the extension portion 20 covers the electrode member 23). With this, as with the first embodiment, the auxiliary capacitor C2 is formed between the light-shielding film 12 and the source electrode 15.

In the scanning line drive circuits according to the first and second examples of the present embodiment, the electrode members 22, 23 are formed in the same layer (semiconductor layer) as the channel portion, and are electrically connected to the first conduction electrode (source electrode 15) of the thin film transistor. With this, the auxiliary capacitor for stabilizing the potential of the light-shielding film can be formed, and as with the first embodiment, it is possible to provide a small-area and low-cost drive circuit of a display device, the drive circuit including a light-shielded thin film transistor. In the scanning line drive circuit according to the second example, the electrode member is formed between the first and second conduction electrodes (between source electrode and drain electrode). Therefore, the auxiliary capacitor can be formed without exerting a large influence on a layout of other portions.

Note that even when the protection target transistor is of the P-channel type, the electrode member is formed in the same layer as the protection target channel portion and the formed electrode member is connected to the source electrode of the protection target transistor. In this case, the high-level potential is fixedly applied to the source electrode as the off potential of the transistor.

### Third Embodiment

A scanning line drive circuit according to a third embodiment of the present invention is different from those according to the first and second embodiments in a method of forming the auxiliary capacitor C2. In the present embodiment, the electrode member is electrically connected to one conduction electrode of a transistor other than the protection target transistor. Differences from the first and second embodiments will be described below.

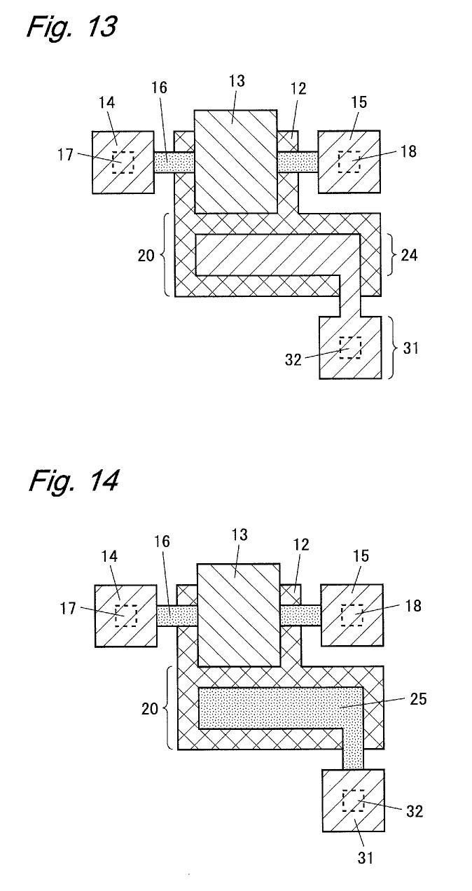

FIGS. 13 to 15 are layout diagrams of the transistor Tr4 and its neighborhood in scanning line drive circuits according to first to third examples of the present embodiment, respectively. In FIGS. 13 to 15, a conduction electrode 31 is either a drain electrode or a source electrode of another transistor. The off potential of the transistor is fixedly applied to the conduction electrode 31. The conduction electrode 31 and the semiconductor portion (not shown) of the other transistor are electrically connected using a contact hole 32.

In the first example (FIG. 13), an electrode member 24 is formed integrally with the conduction electrode 31 in the source layer in order to form the auxiliary capacitor C2. The extension portion 20 of the light-shielding film 12 and the electrode member 24 are formed so as to overlap in a planar view (so that the extension portion 20 covers the electrode member 24). With this, the auxiliary capacitor C2 is formed between the light-shielding film 12 and the conduction electrode 31. In this manner, the auxiliary capacitor for stabilizing the potential of the light-shielding film can be formed using the electrode member formed integrally with the one conduction electrode of the other thin film transistor.

In the second example (FIG. 14), an electrode member 25 is formed in the semiconductor layer in order to form the auxiliary capacitor C2. The electrode member 25 is formed integrally with the semiconductor layer of the other transistor, and is electrically connected to the conduction electrode 31 using the contact hole 32. The extension portion 20 of the light-shielding film 12 and the electrode member 25 are formed so as to overlap in a planar view (so that the extension portion 20 covers the electrode member 25). With this, the auxiliary capacitor C2 is formed between the light-shielding film 12 and the conduction electrode 31. In this manner, the auxiliary capacitor for stabilizing the potential of the light-shielding film can be formed, using the electrode member formed in the same layer (semiconductor layer) as the channel portion and electrically connected to the one conduction electrode of the other thin film transistor.

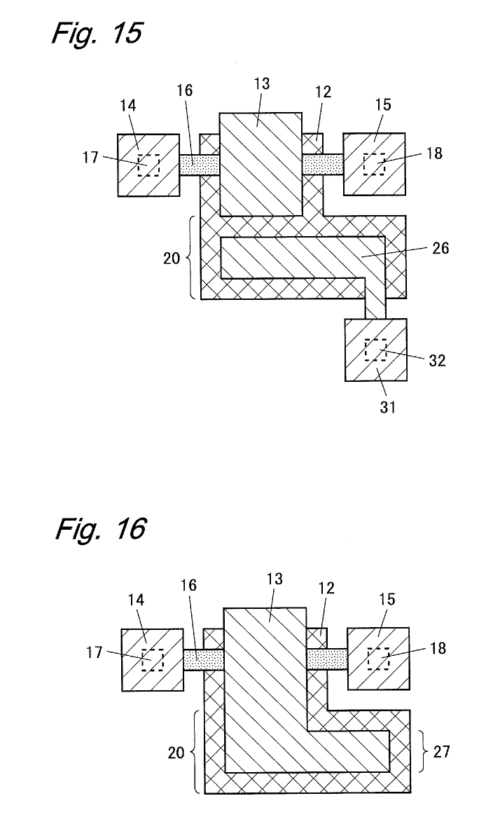

In the third example (FIG. 15), an electrode member 26 is formed in the gate layer in order to form the auxiliary capacitor C2. The electrode member 26 is electrically connected to the conduction electrode 31 using the contact hole 32. The extension portion 20 of the light-shielding film 12 and the electrode member 26 are formed so as to overlap in a planar view (so that the extension portion 20 covers the electrode member 26). With this, the auxiliary capacitor C2 is formed between the light-shielding film 12 and the conduction electrode 31. In this manner, the auxiliary capacitor for stabilizing the potential of the light-shielding film can be formed, using the control electrode formed in the same layer (gate layer) as the control electrode of the thin film transistor and electrically connected to the one conduction electrode of the other thin film transistor.

According to the scanning line drive circuit according to the first to third examples of the present embodiment, it is possible to form the auxiliary capacitor for stabilizing the potential of the light-shielding film, and as with the first and second embodiments, it is possible to provide a small-area and low-cost drive circuit of a display device, the drive circuit including a light-shielded thin film transistor.

### Fourth Embodiment

A scanning line drive circuit according to a fourth embodiment of the present invention is different from those according to the first to third embodiments in a method of forming the auxiliary capacitor C2. In the present embodiment, the electrode member is formed integrally with the control electrode of the protection target transistor. Differences from the fir,t to third embodiments will be described below.

FIG. 16 is a layout diagram of the transistor Tr4 and its neighborhood in the scanning line drive circuit according to the present embodiment. In order to form the auxiliary capacitor C2, an electrode member 27 is formed integrally with the gate electrode 13 in the gate layer. The extension portion 20 of the light-shielding film 12 and the electrode member 27 are formed so as to overlap in a planar view (so that the extension portion 20 covers the electrode member 27). With this, the auxiliary capacitor C2 is formed between the light-shielding film 12 and the gate electrode 13. Unlike the first to third embodiments, in the present embodiment, a same potential as that applied to the gate electrode 13 is applied to the electrode member 27. In this manner, the auxiliary capacitor for stabilizing the potential of the light-shielding film can be formed, using the electrode member formed integrally with the control electrode (orate electrode 13) of the protection target thin film transistor.

According to the scanning line drive circuit according to the present embodiment, it is possible to form the auxiliary capacitor for stabilizing the potential of the light-shielding film, and as with the first to third embodiments, it is possible to provide a small-area and low-cost drive circuit of the display device, the drive circuit including a light-shielded thin film transistor.

### Fifth Embodiment

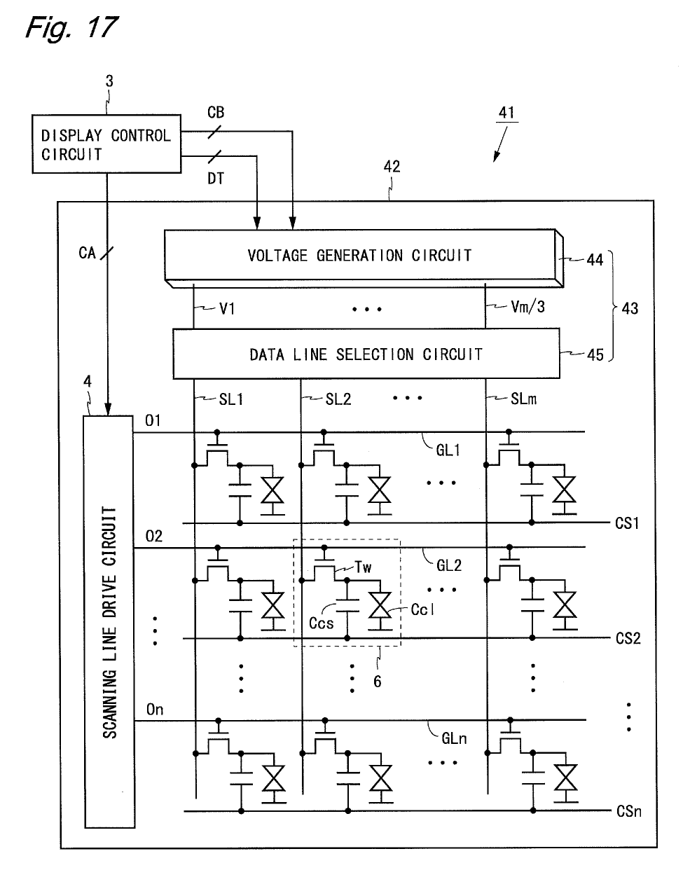

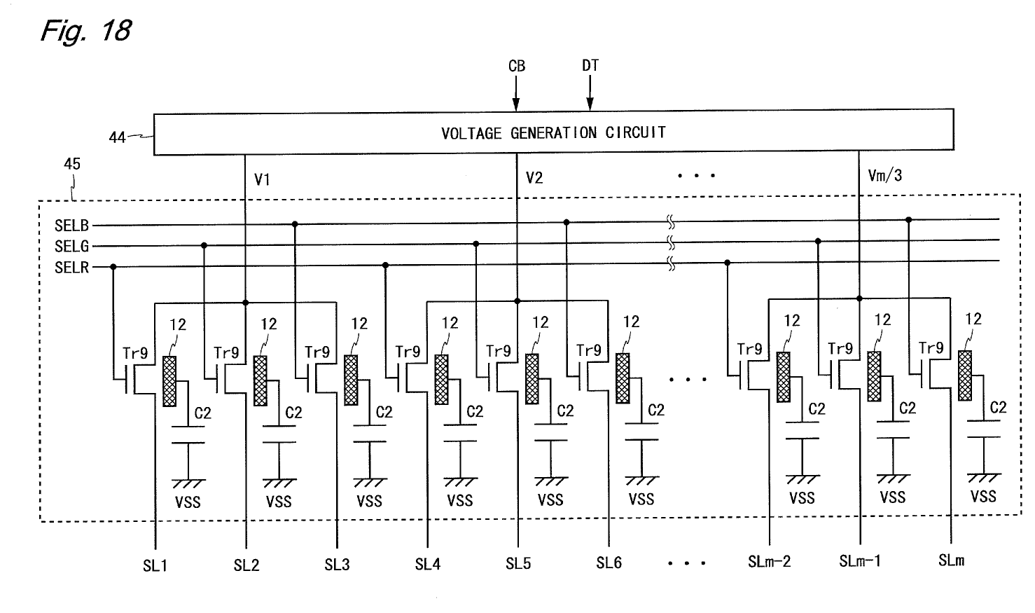

FIG. 17 is a block diagram showing a configuration of a liquid crystal display device including a data line drive circuit according to a fifth embodiment of the present invention. A liquid crystal display device 41 shown in FIG. 17 includes a liquid crystal panel 42, the display control circuit 3, the scanning line drive circuit 4, and a data line drive circuit 43. The data line drive circuit 43 includes a voltage generation circuit 44 and a data line selection circuit 45. Differences from the liquid crystal display device 1 shown in FIG. 1 will be described below.

In the liquid crystal display device 41, the m data lines SL1 to SLm are divided into (m/3) groups, each including three data lines One horizontal period is divided into three periods (hereinafter referred to as first to third periods), and a voltage in accordance with the data signal DT is applied to one of the three data lines in the group in each of the first to third periods.

The voltage generation circuit 44 generates (m/3) voltages in accordance with the data signal DT based on the control signal CB. The data line selection circuit 45 switches to which each of the (m/3) voltages generated by the voltage generation circuit 44 is applied among the three data lines in the group. The voltage generation circuit 44 is included in one or more IC chips. The IC chip including the voltage generation circuit 44 is mounted on a surface of the liquid crystal panel 42. The data line selection circuit 4.5 is formed on the liquid crystal panel 42 together with the pixel circuit 6 using a same manufacturing process for the pixel circuit 6.

FIG. 18 is a circuit diagram of the data line selection circuit 45. As shown in FIG. 18, the data line selection circuit 45 includes m transistors Tr9. The m transistors Tr9 are all N-channel type TFTs and are corresponded one-to-one to the m data lines SL1 to SLm. In the data line selection circuit 45, the m transistors Tr9 are selected as protection target transistors, and the light-shielding film 12 and the auxiliary capacitor C2 are provided corresponding to each transistor Tr9.

One conduction electrode (lower electrode in FIG. 18) of the transistor Tr9 is connected to a corresponding data line. The voltage generation circuit 44 outputs (m/3) voltages 1 to Vm/3. The voltage V1 is supplied to the other conduction electrodes of the first to third transistors Tr9. The voltage V2 is supplied to the other conduction electrodes of the fourth to sixth transistors Tr9. In the similar manner, the voltages V3 to Vm/3 output from the voltage generation circuit 44 are supplied to the other conduction electrodes of the seventh and subsequent transistors Tr9. A selection control signal SELR is supplied to gate electrodes of the first, fourth, . . . transistors Tr9. A selection control signal SELG is supplied to gate electrodes of the second, fifth, . . . transistors Tr9. A selection control signal SELB is supplied to gate electrodes of the third, sixth, . . . transistors Tr9.

In the first period, the voltage generation circuit 44 outputs voltages to be applied to the data lines SL1, SL4, . . . as the Voltages V1 to Vm/3. In the first period, the selection control signal SELR becomes the high level and the first, fourth, . . . transistors Tr9 turn on. Therefore, the voltages V1 to Vm/3 are applied to the data lines SL1, SL4, Similarly, in the second period, the selection control signal SELG becomes the high level and the voltages V1 to Vm/3 are applied to the data lines SL2, SL5, . . . . In the third period, the selection control signal SELB becomes the high level and the voltages V1 to Vm/3 are applied to the data lines SL3, SL6, . . . .

When the selection control signal SELR is at the low level, the first, fourth, . . . transistors Tr9 turn off and the data lines SL1, SL4, . . . (one conduction electrodes of the first, fourth, transistors Tr9) become the floating state. Similarly, the data lines SL2, SL5, . . . become the floating; state when the selection control signal SELG is at the low level. The data lines SL3, SL6, . . . become the floating state when the selection control signal SELB is at the low level.

A power supply line having the high-level potential VDD and a power supply line having the low-level potential VSS are formed on the liquid crystal panel 42. As with the first to fourth embodiments, the light-shielding film 12 has the main body portion for shielding a channel portion of the transistor Tr9, and the extension portion formed integrally with the main body portion, and is formed so at to be electrically isolated. In order to form the auxiliary capacitor C2, an electrode member is formed in one of the semiconductor layer, the gate layer, and the source layer. The electrode member is formed integrally with the power supply line having the low-level potential VSS, or is electrically connected to the power supply line having the low-level potential VSS using a contact hole. The extension portion of the light-shielding film 12 and the electrode member are formed so as to overlap in a planar view (so that the extension portion covers the electrode member). With this, the auxiliary capacitor C2 is formed between the light-shielding film 12 and the power supply line having the low-level potential.

In this manner, a part of the data line drive circuit 43 is formed on the liquid crystal panel 42. In the data line drive circuit 43 (data line selection circuit 45) formed on the liquid crystal panel 42, the light-shielding film 12 and the auxiliary capacitor C2 are provided corresponding to the transistor Tr9 which is the protection target transistor, in a manner similar to that in the third embodiment. Therefore, according to the data line drive circuit 43, as with the first to fourth embodiments, it is possible to provide a small-area and low-cost drive circuit of the display device, the drive circuit including a light-shielded thin film transistor.

Furthermore, the liquid crystal display device 41 shown in FIG. 17 includes a display panel liquid crystal panel 42) including the plurality of the scanning lines GL1 to GLn, the plurality of the data lines SL1 to SLm, and the plurality of the pixel circuits 6, the scanning line drive circuit 4 for driving the scanning lines, and the data line drive circuit 43 for driving the data lines. A part of the data line drive circuit 43 (data line selection circuit 45) is formed on the display panel and has an above-described configuration. Therefore, a reliable and low-cost display device can be provided using a small-area and low-cost drive circuit of the display device, the drive circuit including a light-shielded thin film transistor.

A case in which the scanning line drive circuit is formed on the display panel is described in the first embodiment, and a case in which a part of the data line drive circuit is formed on the display panel is described in the fifth embodiment. The present invention can be applied to a case in which a part of the scanning line drive circuit is formed on the display panel, a case in which a part of the data line drive circuit and the scanning line drive circuit are formed on the display panel, a case in which both of the scanning line drive circuit and the data line drive circuit are formed on the display panel, and other cases. The present invention can be applied to a display device in which at least a part of at least one of the scanning line drive circuit and the data line drive circuit is formed on a display panel.

Furthermore, the present invention can also be applied to scanning line drive circuits other than the scanning line drive circuits according to the first to fourth embodiments, and data line drive circuits other the data line drive circuit according to the fifth embodiment. Furthermore, although cases in which a specific TFT included in the drive circuit is selected as the protection target transistor are described in the first to fifth embodiments, an arbitrary TFT included in the drive circuit maybe selected as the protection target transistor. Furthermore, all the TFTs included in the drive circuit may be the protection target transistors.

### INDUSTRIAL APPLICABILITY

Since the drive circuit of the display device of the present invention has a feature of including a light shielded thin film transistor ad being small-area and low-cost, it can be used as a drive circuit of various types of active-matrix type display devices.

### DESCRIPTION OF REFERENCE CHARACTERS

1, 41: LIQUID CRYSTAL DISPLAY DEVICE

2, 42: LIQUID CRYSTAL PANEL

3: DISPLAY CONTROL CIRCUIT

4: SCANNING LINE DRIVE CIRCUIT

5, 43: DATA LINE DRIVE CIRCUIT

6: PIXEL CIRCUIT

10: SHIFT REGISTER

11: UNIT CIRCUIT

12: LIGHT-SHIELDING FILM

13: GATE ELECTRODE

14: DRAIN ELECTRODE

15: SOURCE ELECTRODE

16: SEMICONDUCTOR PORTION

17, 18, 32: CONTACT HOLE

19: MAIN BODY PORTION

20: EXTENSION PORTION

21 to 27: ELECTRODE MEMBER

31: CONDUCTION ELECTRODE

44: VOLTAGE GENERATION CIRCUIT

45: DATA LINE SELECTION CIRCUIT

Tr1 to Tr9: TRANSISTOR

C1: CAPACITOR

C2: AUXILIARY CAPACITOR

1. A drive circuit of a display device, formed on a display panel, the drive circuit comprising:
a thin film transistor having a first conduction electrode, a second conduction electrode, and a control electrode;
an electrically isolated light-shielding film having a main body portion configured to shield a channel portion of the thin film transistor, and an extension portion formed integrally with the main body portion; and
an auxiliary capacitor formed by overlapping the extension portion of the light-shielding film with an electrode member in a planar view.

2. The drive circuit according to claim 1, wherein an off potential of the thin film transistor is fixedly applied to the electrode member.

3. The drive circuit according to claim 2, wherein the electrode member is formed integrally with the first conduction electrode.

4. The drive circuit according to claim 2, wherein the electrode member is formed in a same layer as the channel portion and is electrically connected to the first conduction electrode.

5. The drive circuit according to claim 4, wherein the electrode member is formed between the first and second conduction electrodes.

6. The drive circuit according to claim 2, wherein the electrode member is electrically connected to one conduction electrode of another thin film transistor other than the thin film transistor.

7. The drive circuit according to claim 6, wherein the electrode member is formed integrally with the one conduction electrode of the other thin film transistor.

8. The drive circuit according to claim 6, wherein the electrode member is formed in a same layer as the channel portion.

9. The drive circuit according to claim 6, wherein the electrode member is formed in a same layer as the control electrode.

10. The drive circuit according to claim 1, wherein the electrode member is formed integrally with the control electrode.

11. A display device comprising:
a display panel including a plurality of scanning lines, a plurality of data lines, and a plurality of pixel circuits;
a scanning line drive circuit configured to drive the scanning lines; and
a data line drive circuit configured to drive the data lines, wherein
at least a part of at least one of the scanning line drive circuit and the data line drive circuit is formed on the display panel and includes:
a thin film transistor having a first conduction electrode, a second conduction electrode, and a control electrode;
an electrically isolated light-shielding film having a main body portion configured to shield a channel portion of the thin film transistor, and an extension portion formed integrally with the main body portion; and
an auxiliary capacitor formed by overlapping the extension portion of the light-shielding film with an electrode member in a planar view.
